(19) United States
(12) Patent Application Publication
(10) Pub. No.: US 2013/0083049 A1
(43) Pub. Date: Apr. 4, 2013

(54) IMAGE DISPLAY SYSTEM, IMAGE DISPLAY APPARATUS, SERVER, IMAGE DISPLAY METHOD AND STORAGE MEDIUM STORING A PROGRAM

(71) Applicant: Kimiyasu MIZUNO, Tokyo (JP)

(72) Inventor: Kimiyasu MIZUNO, Tokyo (JP)

(21) Appl. No.: 13/611,702

(22) Filed: Sep. 12, 2012

(30) Foreign Application Priority Data
Sep. 30, 2011 (JP) 2011-216258

(51) Int. Cl. G09G 5/00

(52) U.S. Cl. 345/581

(57) ABSTRACT

In an image display system, a server determines whether or not an attribute of a display of plural images that is executed at one image display apparatus matches an attribute of a display of plural images that is executed at another image display apparatus. If the attributes match, the server reports to both the image display apparatuses that there is another image display apparatus displaying plural images with a matching attribute. Hence, the users of the two image display apparatuses may communicate through images with one another, prompted by interesting information such as a similarity in hobbies or preferences or the like.

This application is based on and claims the benefit of priority from Japanese Patent Application No. 2011-216258, filed on 30 Sep. 2011, the content of which is incorporated herein by reference.

### BACKGROUND OF THE INVENTION

1. Field of the Invention

The present invention relates to an image display system, an image display apparatus, a server, an image display method and storage medium storing a program.

2. Related Art

In recent years, with the spread of digital cameras, additional information such as dates and times of imaging and locations of imaging have been memorized along with image data, and various applications that make use of this information in image display apparatuses have been proposed.

For example, in the system recited in Japanese Unexamined Patent Publication No. 2009-86736, the imaging date and time, imaging location and the like of image data are specified by a server on the basis of image data and the like received from a first client apparatus, and image data that was imaged within a predetermined period at a location close to a current position of a second client apparatus is transmitted to the second client apparatus.

Thus, image data from within the predetermined period from the imaging date and time may be transmitted to a client device that is disposed close to the imaging location of the image, and on the basis of matching of imaging dates and times, imaging locations and the like, communication between the users of a plural number of client apparatuses is realized.

In a related art image display system including the technology recited in Japanese Unexamined Patent Publication No. 2009-86736, communication between users is possible by reference to standard information such as the imaging location, imaging date and time and the like of an image. However, communication between users that is prompted by images on the basis of information on what is interesting to the users, such as hobbies and preferences, is difficult.

That is, when users communicate through images with the related art image display system, the information that is used as prompts for communication is not sufficiently interesting for the users.

### SUMMARY OF THE INVENTION

The present invention has been made in consideration of this situation, and an object of the invention is to enable communication between users through images, prompted by information that is of greater interest.

In order to achieve the object described above, a first aspect of an image display system of the present invention

includes: a plurality of image display apparatuses that display images based on image data; and a server connected with the plurality of image display apparatuses via a network, wherein

each image display apparatus includes:

an image attribute setting unit that sets an attribute relating to the image data for each set of image data;

an image data storage unit that stores the image data in association with the attributes relating to the image data set by the image attribute setting unit;

a display attribute setting unit that refers to the image data and attributes relating to the image data stored at the image data storage unit, aggregates the attributes set for a plurality of sets of image data that are selected as objects to be displayed, and sets an attribute of the objects to be displayed;

a transmission unit that transmits the attribute of the objects to be displayed set by the display attribute setting unit to the server together with identification information of the image display apparatus; and

a message display unit that displays an attribute match message that is transmitted from the server to report that another of the image display apparatuses matches the attribute of the objects to be displayed,

and

the server includes:

an attribute data storage unit that stores the attributes of objects to be displayed that are transmitted from the image display apparatuses, in association with the identification information of the image display apparatuses; and

a message transmission unit that, if a plurality of the attributes of objects to be displayed stored at the attribute data storage unit match, transmits an attribute match message to each of the image display apparatuses associated with the plurality of attributes of objects to be displayed, on the basis of the identification information of the image display apparatuses.

According to the invention, users may communicate through images with information of greater interest as prompts.

### BRIEF DESCRIPTION OF THE DRAWINGS

FIG. 1 is a diagram showing structure of a digital photo frame system that serves as an embodiment in accordance with an image display system of the present invention.

FIG. 2 is a block diagram showing hardware structure of a digital photo frame in accordance with a first embodiment of the present invention.

FIG. 3 is a block diagram showing hardware structure of a server in accordance with the first embodiment of the present invention.

FIG. 4 is a block diagram showing functional structures for executing image attribute setting processing, slideshow attribute setting processing, message display processing and conversation control processing at the digital photo frame.

FIG. 5 is a diagram illustrating a data structure of an image database

FIG. 6 is a diagram illustrating an example of a display screen displaying an attribute match message.

FIG. 7 is a functional block diagram showing functional structures for executing message transmission processing at the server.

FIG. 8 is a diagram illustrating a data structure of an attribute database.

FIG. 9 is a flowchart describing the flow of the image attribute setting processing executed by the digital photo frame of FIG. 2 with the functional structures of FIG. 4.

FIG. 10 is a flowchart describing the flow of the slideshow attribute setting processing executed by the digital photo frame with the functional structures of FIG. 4.

FIG. 11 is a flowchart describing the flow of the message display processing executed by the digital photo frame with the functional structures of FIG. 4.

FIG. 12 is a flowchart describing the flow of the message transmission processing executed by a server with the functional structures of FIG. 7.

### DETAILED DESCRIPTION OF THE INVENTION

Herebelow, an image display system of a first embodiment of the present invention is described on the basis of the drawings.

### Structure of Image Display System

In an image display system according to the present embodiment, a server makes a determination as to whether attributes of a successive display of plural images (for example, a slideshow display) that is executed at one image display apparatus match attributes of a successive display of plural images that is executed at another image display apparatus. If these attributes match up, the server reports to each of the two image display apparatuses that there is present an image display apparatus that is performing a successive display of plural images with matching attributes. Hence, the users of the two image display apparatuses may communicate through images with one another, prompted by interesting information such as a similarity in hobbies or preferences or the like.

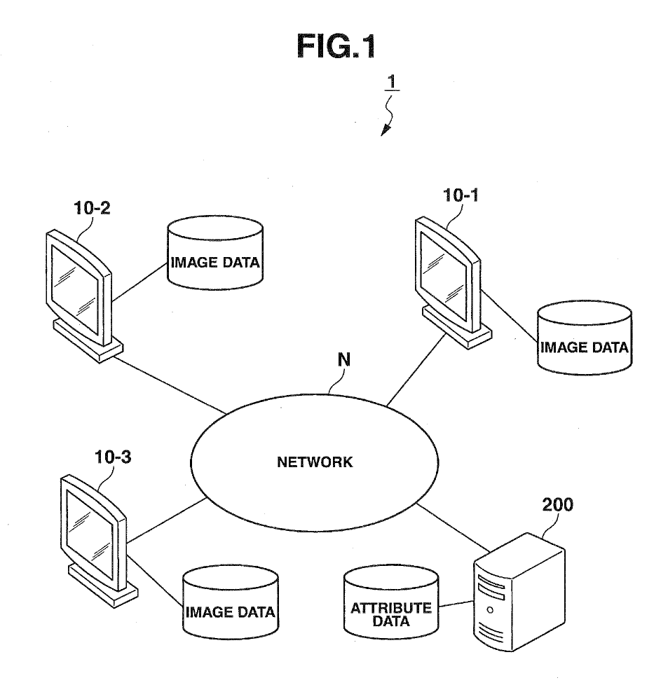

FIG. 1 shows the structure of a digital photo frame system 1 that serves as an embodiment according to the image display system of the present invention. In FIG. 1, digital photo frames 10-1 to 10-3 are illustrated as examples of the image display apparatus of the present invention.

The digital photo frame system 1 is constituted in the example in FIG. 1 by the three digital photo frames 10-1 to 10-3 and a server 200 being connected via a network N.

The digital photo frames 10-1 to 10-3 are disposed with users at remote locations. Specifically, the digital photo frame 10-1 is set up at the home of grandparents G, the digital photo frame 10-2 is set up at the home of a grandchild A of the grandparents G, and the digital photo frame 10-3 is set up at another home.

The number of the digital photo frames 10 is three in the example in FIG. 1, but the example in FIG. 1 is not particularly limiting and the number may be an arbitrary number.

Hereinafter, where it is not necessary to individually distinguish the digital photo frames 10-1 to 10-3, they are collectively referred to simply as the digital photo frames 10. Where a digital photo frame 10 is being referred to, the suffixes -1 to -3 are omitted from the reference numerals of the structural elements of the digital photo frame 10.

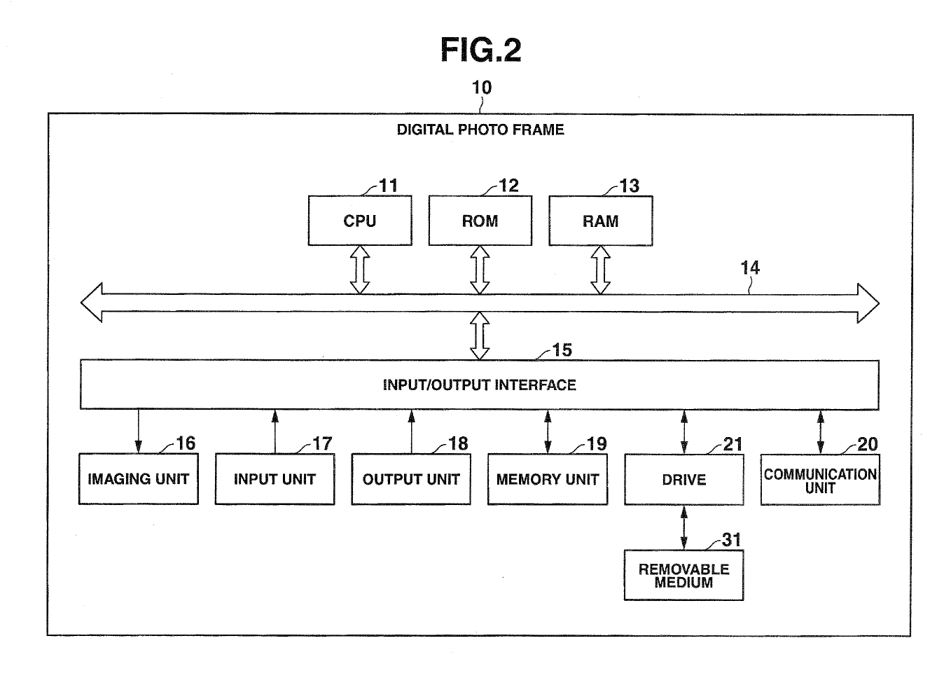

FIG. 2 is a block diagram showing hardware structure of the digital photo frame 10 according to the first embodiment of the present invention.

In FIG. 2, the digital photo frame 10 is equipped with a central processing unit (CPU) 11, a read-only memory (ROM) 12, a random access memory (RAM) 13, a bus 14, an input/output interface 15, an imaging unit 16, an input unit 17, an output unit 18, a memory unit 19, a communication unit 20 and a drive 21.

The CPU 11 executes various processes in accordance with a program recorded in the ROM 12 or a program loaded into the RAM 13 from the memory section 19.

Data and suchlike that is required for execution of the various processes by the CPU 11 is stored in the RAM 13 as appropriate.

The CPU 11, the ROM 12 and the RAM 13 are connected to one another via the bus 14. The input/output interface 15 is also connected to the bus 14. The imaging unit 16, the input unit 17, the output unit 18, the memory unit 19, the communications section 20 and the drive 21 are connected to the input/output interface 15.

The imaging unit 16 is provided with an optical lens unit and an image sensor, which are not shown in the drawings.

The optical lens unit is configured with lenses that focus light for imaging subjects, e.g., a focus lens, a zoom lens and the like.

The focus lens is a lens for forming an image of a subject on a light detection surface of the image sensor. The zoom lens is a lens for freely varying the focusing distance within a predetermined range.

The optical lens unit also includes peripheral circuits for adjusting setting parameters, such as focus, exposure, white balance, and the like, as necessary.

The image sensor is configured with an optoelectronic conversion device, an AFE (Analog Front End), and the like.

The optoelectronic conversion device is configured by, for example, a CMOS-based (complementary metal oxide semiconductor) optoelectronic conversion device or the like. An image of a subject is incident on the optoelectronic conversion device through the optical lens unit. The optoelectronic conversion device optoelectronically converts (captures) the image of the subject, accumulates the resultant image signals for a predetermined duration, and sequentially supplies the accumulated image signals to the AFE as analog signals.

The AFE applies various kinds of signal processing such as analog-to-digital (A/D) conversion processing and the like to the analog image signals. The various kinds of signal processing generate digital signals, which are outputted as output signals from the imaging unit 16.

The output signals from the imaging unit 16 are referred to hereinafter as “captured image data”. Data of captured images is provided to the CPU 11 and the like as appropriate.

The input unit 17 is constituted with various buttons and the like and inputs various kinds of information in accordance with instruction operations by a user. The input unit 17 also includes a microphone and an A/D conversion circuit or the like. The input unit 17 outputs voice data inputted through the microphone to the CPU 11 or the memory unit 19.

The output unit 18 includes a display, a speaker and digital-to-analog (D/A) conversion circuit, and the like. The output unit 18 outputs images and sounds or the like.

The memory unit 19 is configured with a hard disc, dynamic random access memory (DRAM) or the like. The memory unit 19 stores an image database in which data and attributes of various images are saved.

The communications unit 20 controls communications with other devices (digital photo frames, a server, a suitably provided database server and the like) over networks, including the Internet.

A removable medium 31, such as a magnetic disc, an optical disc, a magneto-optical disc, a semiconductor memory or the like, is loaded at the drive 21 as appropriate. A program that is read from the removable medium 31 by the drive 21 is installed in the memory unit 19 as required. Similarly to the memory unit 19, the removable medium 31 may also store the various kinds of data such as image data and the like that are stored in the memory section 19.

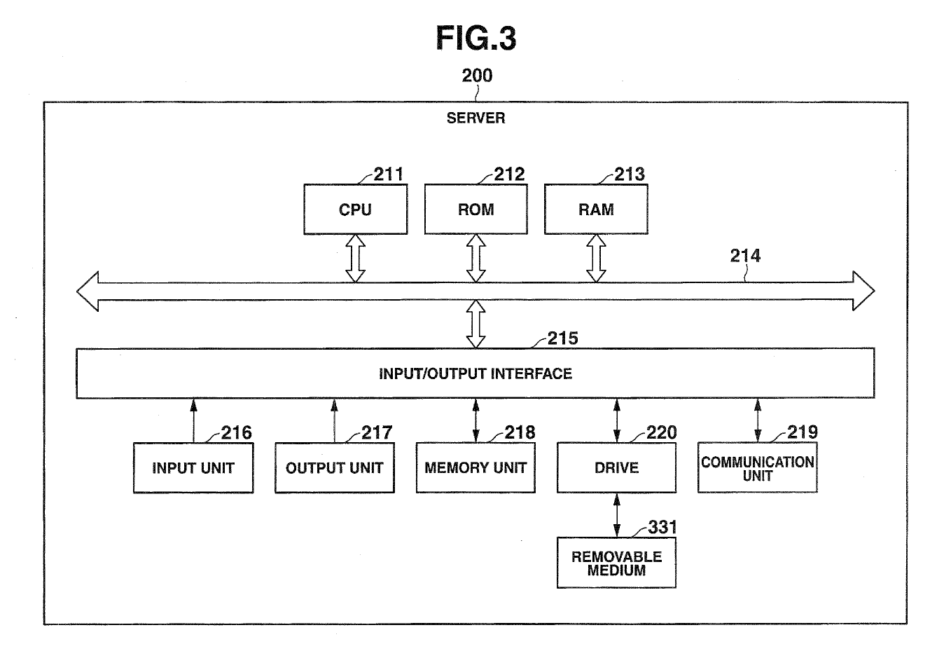

FIG. 3 is a block diagram showing hardware structure of the server 200 according to the first embodiment of the present invention.

In FIG. 3, the server 200 is equipped with a central processing unit (CPU) 211, a read-only memory (ROM) 212, a random access memory (RAM) 213, a bus 214, an input/output interface 215, an input unit 216, an output unit 217, a memory unit 218, a communication unit 219 and a drive 220.

The CPU 211 executes various processes in accordance with a program recorded in the ROM 212 or a program loaded into the RAM 213 from the memory unit 218.

Data and suchlike that is required for execution of the various processes by the CPU 211 is stored in the RAM 213 as appropriate.

The CPU 211, the ROM 212 and the RAM 213 are connected to one another via the bus 214. The input/output interface 215 is also connected to the bus 214. The input unit 216, the output unit 217, the memory unit 218, the communication unit 219 and the drive 220 are connected to the input/output interface 215.

The input unit 216 is constituted with various buttons and the like and inputs various kinds of information in accordance with instruction operations by a user. The input unit 216 also includes a microphone and an A/D conversion circuit or the like. The input unit 216 outputs voice data inputted through the microphone to the CPU 211 or the memory unit 218. The output unit 217 includes a display, a speaker and D/A conversion circuit, and the like. The output unit 217 outputs images, sounds and the like. The memory unit 218 is configured with a hard disc, DRAM or the like. The memory unit 218 stores an attribute database in which attributes of slideshow displays transmitted from the digital photo frames 10 are stored together with device IDs that identify the digital photo frames 10 that are the transmission sources.

The communications unit 219 controls communications with other devices (digital photo frames, a suitably provided database server and the like) over networks, including the Internet.

A removable medium 331, such as a magnetic disc, an optical disc, a magneto-optical disc, a semiconductor memory or the like, is loaded at the drive 220 as appropriate. A program that is read from the removable medium 331 by the drive 220 is installed in the memory unit 218 as required. Similarly to the memory section 218, the removable medium 331 may also store the various kinds of data such as image data and the like that are stored in the memory section 218.

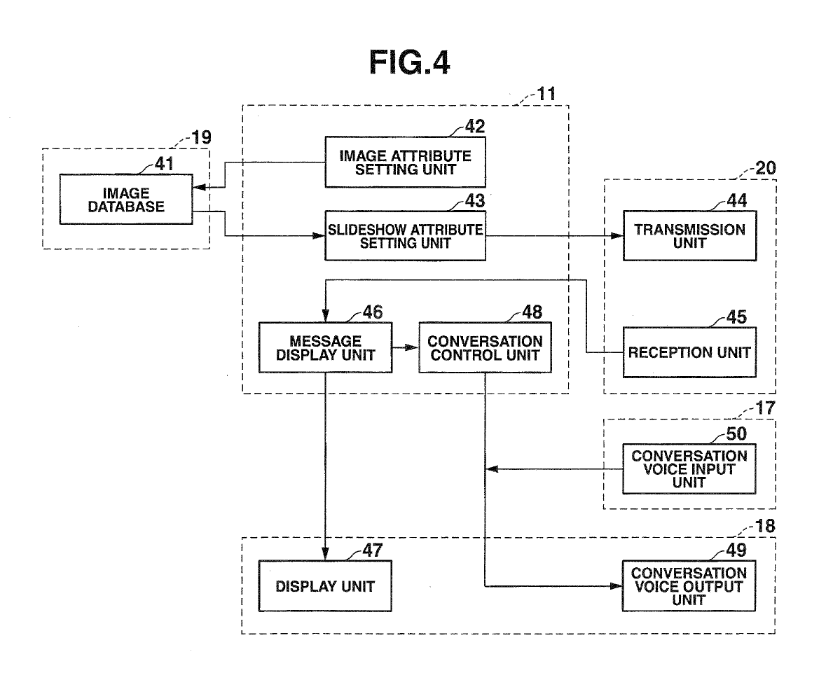

FIG. 4 is a block diagram showing functional structures for executing image attribute setting processing, slideshow attribute setting processing, message display processing and conversation control processing at the digital photo frame 10.

The image attribute setting processing is processing that sets various attributes in image data that is selectable as objects of a slideshow display at the digital photo frame 10.

The slideshow attribute setting processing is a sequence of processing that aggregates attributes of image data included in a slideshow display specified at the digital photo frame 10, calculates overall attributes of the slideshow display, and transmits the calculated slideshow attributes to the server 200 together with the device ID and a client name.

The message display processing is a sequence of processing that, on the basis of a message transmitted from the server 200, shows that another digital photo frame 10 is running a slideshow display with matching attributes.

The conversation control processing is a sequence of processing that, when it is shown by the message display processing that another digital photo frame 10 is running a slideshow display with matching attributes, is executed in order to implement a conversation with the other digital photo frame 10.

The input unit 17 is provided with a conversation voice input unit 50, at which vocal sounds are inputted during a conversation.

The CPU 11 is equipped with an image attribute setting unit 42 that executes the image attribute setting processing, a slideshow attribute setting unit 43 that executes the slideshow attribute setting processing, a message display unit 46 that executes the message display processing and a conversation control unit 48 that executes the conversation control processing. An image database 41 is provided in a region of the memory unit 19.

The image database 41 stores data of images that are selectable as images for slideshow displays, in association with respective attributes of the image data.

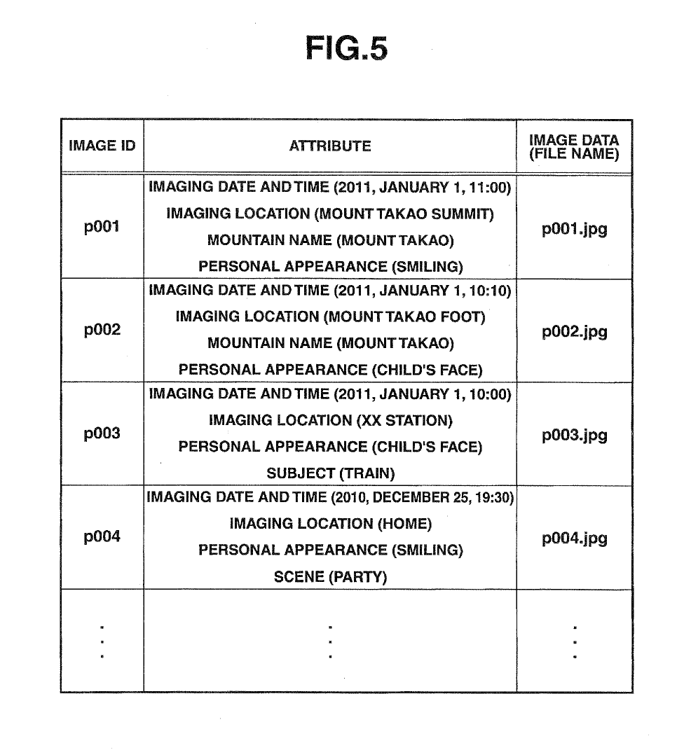

FIG. 5 is a diagram illustrating a data structure of the image database 41.

In FIG. 5, image IDs for identifying image data, attributes set for the image data and file names of the image data are associated and stored in the image database 41.

A row of the image database 41 corresponds to data of a single image. For example, from the stored contents of the first row, it can be seen that for the image data with the image ID “p001”, an imaging date and time of “2011 Jan. 1, 11:00”, an imaging location of “Mount Takao summit” and a mountain name of “Mount Takao” are set as attributes, and the file name of the image data is “p001.jpg”.

The attributes of the image data in the image database 41 are acquired by: automatic saving by a camera in the exif header of a jpeg file at the time of image capture; setting of tags by a user to reflect their hobbies, preferences and the like; when a photograph or video image processing tool is used, saving by the processing tool; information obtained by analysis of a photograph or video image being saved by a user; or the like.

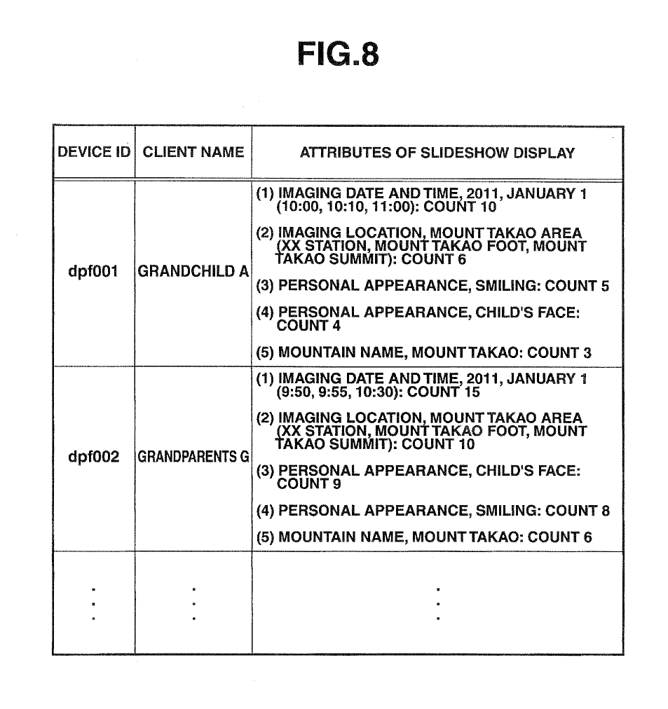

In the slideshow attribute setting processing, overall attributes of a slideshow display are set (see FIG. 8) by the attributes set in the data of images selected as objects of the slideshow display being aggregated.

The output unit 18 is equipped with a display unit 47 and a conversation voice output unit 49. The display unit 47 displays information reported from the server 200 (hereinafter referred to as an attribute match message) that shows that the attributes match up with a slideshow display at another digital photo frame 10. The conversation voice output unit 49 outputs vocal sounds during a conversation.

The communication unit 20 is equipped with a transmission unit 44 and a reception unit 45. The transmission unit 44 transmits attributes of a slideshow display set by the slideshow attribute setting unit 43 to the server 200. The reception unit 45 receives an attribute match message that is transmitted from the server 200 relating to a slideshow display at another digital photo frame 10.

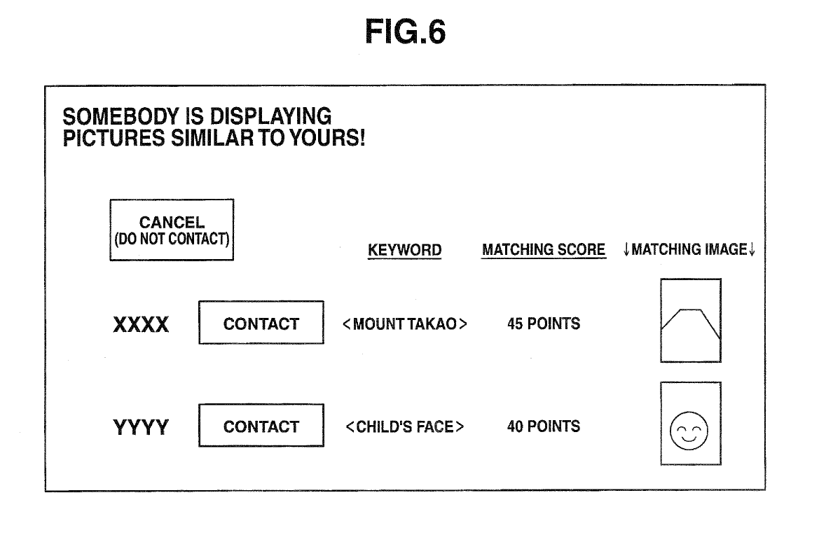

FIG. 6 is a diagram illustrating an example of a display screen that displays the attribute match message.

In the display screen example shown in FIG. 6, the following are displayed: a message that there is another digital photo frame 10 running a slideshow display whose attributes match the attributes of the slideshow display (the character string “Somebody is displaying pictures similar to yours!”); the client name of each digital photo frame 10 with matching slideshow display attributes (the character strings “XXXX” and “YYYY”); a button for inputting an instruction to converse with the digital photo frame 10 of each client name (the “Contact” button); and a button for inputting an instruction to not converse (the button “Cancel (do not contact)”).

In the image display example shown in FIG. 6, the following are displayed for the slideshow display attributes of the digital photo frame 10 of each client name: a keyword of the attribute matching; an attribute matching score; an image representing the matching of attributes (the image with the closest attribute matching, a sample animated image or the like). For the keyword, a keyword included in the slideshow attributes (for example, one or plural keywords with the highest frequency of occurrence) is extracted and displayed. For the attribute matching score, a value transmitted from the server 200 by the message transmission processing, which is described below, is displayed. As the image representing the attribute matching, data of an image with attributes closest to the attributes of the slideshow display at the other digital photo frame 10 is selected from the images of the slideshow display. When similarity is being determined between the attributes of the data of each image and the attributes of the slideshow display at the other digital photo frame 10, numbers of attributes set for the data of each image that coincide with the attributes of the slideshow display at the other digital photo frame 10 may be found, the numbers compared, and an image with the greatest number of coincidences may be selected, or the like.

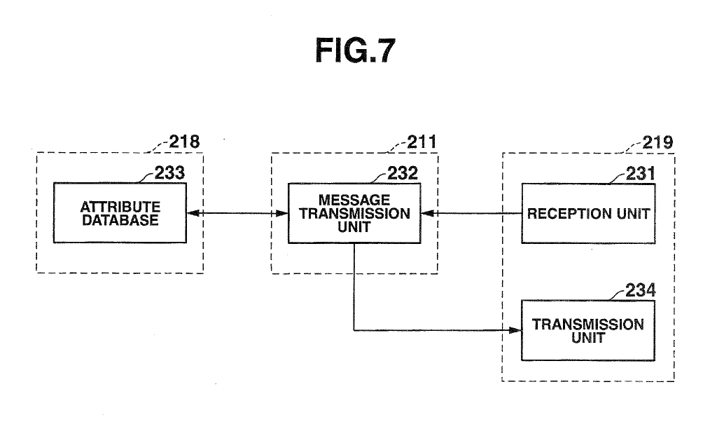

FIG. 7 is a functional block diagram showing functional structures for executing the message transmission processing at the server 200.

The message transmission processing is a sequence of processing that refers to slideshow attributes transmitted from the digital photo frames 10, makes determinations as to whether the attributes of the slideshow displays match up with one another, and transmits an attribute match message to each of digital photo frames 10 running matching slideshow displays.

The CPU 211 is equipped with a message transmission unit 232 that executes the message transmission processing.

An attribute database 233 is provided at a region of the memory unit 218. The attribute database 233 stores slideshow display attributes transmitted from the digital photo frames 10, in association with the device IDs that identify the digital photo frames 10 that are the sources of the transmissions.

FIG. 8 is a diagram illustrating a data structure of the attribute database 233.

In the attribute database 233 in FIG. 8, the following are associated and stored: the device ID that identifies a digital photo frame 10; the client name set for the digital photo frame 10 with that device ID; and the slideshow display attributes transmitted from the digital photo frame 10 with that device ID (values and counts of attributes). Although not shown in the drawing, the image IDs of the sets of image data that are the basis for each element included in the values of the slideshow display attribute are attached to that element.

A row of the attribute database 233 corresponds with the attributes of a single slideshow display. For example, according to the stored details in the first row, the attributes of a slideshow display for which the device ID is “dpf001” are set to a client name of “grandchild A” and the following slideshow display attributes: Imaging date and time, 2011 Jan. 1 (10:00, 10:10, 11:00), count 10; Imaging location, Mount Takao area (XX station, Mount Takao foot, Mount Takao summit), count 6; Personal appearance, smiling, count 5; Personal appearance, child's face, count 4; Mountain name, Mount Takao, count 3.

As shown in FIG. 8, for attribute values for which a higher-level concept can be specified for plural elements covered by the attribute value, such as the same date (the imaging date being 2011 Jan. 1), the same sightseeing area (the imaging location being the Mount Takao area) or the like, the higher-level concept may be set as the attribute value. However, rather than setting higher-level concepts, slide show display attributes may be set by aggregating the attributes set in the image data for each attribute value.

The device IDs of the digital photo frames 10 are transmitted from the digital photo frames 10 together with the slideshow display attributes, and are information that identifies each digital photo frame 10.

The client name is a name set by the user of each digital photo frame 10 (for example, a user name or the like).

The slideshow display attributes are the attributes of slideshows that are set by the slideshow attribute setting processing at each digital photo frame 10.

The communication unit 219 is equipped with a reception unit 231 and a transmission unit 234. The reception unit 231 receives the client names, slideshow display attributes and device IDs from the digital photo frames 10. The transmission unit 234 transmits messages that are transmitted by the message transmission processing.

In the present embodiment, the image attribute setting processing is applied to the image data stored in each digital photo frame 10, and various attributes are set for each set of image data. When a slideshow display is specified, the slideshow attribute setting processing is executed, and attributes of the image data included in the slideshow display are aggregated. Thus, overall attributes of the slideshow display are set. The slideshow display attributes that are set at this time are transmitted to the server 200 together with the device ID and client name of the digital photo frame 10.

At the server 200, received slideshow display attributes and digital photo frame 10 device IDs are saved in the attribute database 233 and, by execution of the message transmission processing, determinations are made as to whether the slideshow display attributes applied at the plural digital photo frames 10 match up. To each of a pair of digital photo frames 10 with device IDs for which the slideshow display attributes match, attribute match messages with the client name set for the other digital photo frame 10 and a slideshow display attribute matching score are transmitted.

A digital photo frame 10 receiving an attribute match message displays the client name and slideshow display attribute matching score included in the attribute match message. If a user performs an operation for conversing with another digital photo frame 10 whose client name is displayed, a conversation between plural digital photo frames 10 is implemented via the server 200.

For example, grandchild A and grandparents G who live in separate homes go on a trip together and return to their respective homes. Later, at about the same time, each sets up a slideshow display of images captured during the trip. At this time, when image data is stored in each digital photo frame 10, image attribute setting processing is executed and attributes are set in the data of each image, such as the dates and times and locations of the trip, combinations of people in the subjects, facial information (expressions and the like), and so forth. When the images for each slideshow display are selected, the slideshow attribute setting processing is executed, and the slideshow display attributes are transmitted to the server 200.

At the server 200, determinations are made as to whether the slideshow display attributes transmitted from the digital photo frame 10-1 disposed at the home of grandchild A and the digital photo frame 10-2 disposed at the home of grandparents G match up. In this case, because it is the same trip and the same subjects and the like, the dates and times of imaging, locations of imaging, combinations of people in the subjects and the like are similar, and it is determined that the attributes match up. Accordingly, attribute match messages are transmitted to the digital photo frame 10-1 disposed at the home of grandchild A and the digital photo frame 10-2 disposed at the home of grandparents G, including one another's client names and the slideshow display attribute matching score.

Then, if one of grandchild A and grandparents G performs the operation for conversing at their digital photo frame 10, a check of whether or not to accept the conversation is implemented at the other digital photo frame 10, and if a response indicating acceptance is given, a conversation is implemented between the digital photo frames 10, and the slideshows being displayed may be discussed.

### Operation

Now, operation of the digital photo frames 10 and the server 200 is described.

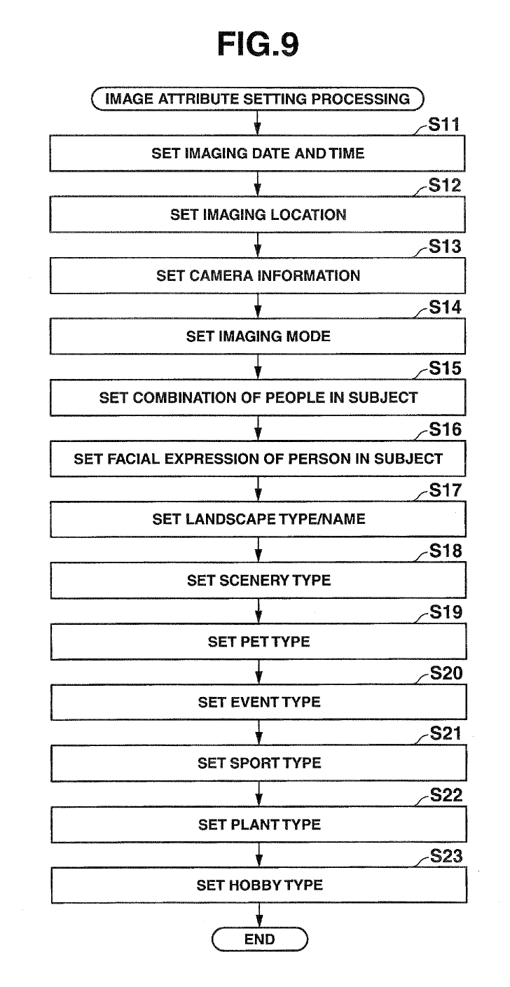

First, of the processes that are executed by the digital photo frame 10 with the functional structures in FIG. 4, the image attribute setting processing is described with reference to FIG. 9.

FIG. 9 is a flowchart describing the flow of the image attribute setting processing executed by the digital photo frame 10 of FIG. 2 with the functional structures of FIG. 4.

In the present embodiment, after a power supply of the digital photo frame 10 is turned on, the image attribute setting processing is executed each time new image data is stored.

The various attributes in the following descriptions are acquired by: automatic saving by a camera in the exif header of a jpeg file at the time of image capture; setting of tags by a user; when a photograph or video image processing tool is used, saving by the processing tool; information obtained by analysis of a photograph or video image being saved by a user; or the like. The image attribute setting unit 42 sets this acquired information as the attributes. In particular, if tags representing types based on hobbies, preferences and the like are set by the users themselves and these tags are set as attributes of the image data, then hobbies, preferences and the like of users may be reflected in the attributes.

In step S11, the image attribute setting unit 42 sets an imaging date and time as a single attribute of the new image data stored in the image database 41.

In step S12, the image attribute setting unit 42 sets an imaging location (position, altitude and imaging direction) as a single attribute.

Herein, information acquired by GPS (the Global Positioning System) may be used for the imaging location and imaging date and time.

In step S13, the image attribute setting unit 42 sets camera information (the maker and model name) as a single attribute.

In step S14, the image attribute setting unit 42 sets an imaging mode as a single attribute (HDR (high dynamic range), high-speed shooting, slow shutter, panning or the like).

In step S15, the image attribute setting unit 42 sets a combination of people in the subject (a baby, a child, a pair) as a single attribute.

In step S16, the image attribute setting unit 42 sets a facial expression of a person in the subject as a single attribute (smiling, crying, angry, sad, a baby or child's face, or the like).

In step S17, the image attribute setting unit 42 sets a type or name of a landscape as a single attribute (mountain, sea, lake, a mountain name, a beach name, a sea name, a river or lake name, snow scene, desert or the like).

In step S18, the image attribute setting unit 42 sets a type of scenery as a single attribute (a building, a World Heritage Site, historic remains or the like).

In step S19, the image attribute setting unit 42 sets a type of pet as a single attribute (a dog, cat, reptile, bird, insect or the like).

In step S20, the image attribute setting unit 42 sets a type of event as a single attribute (a sports day, festival, choral concert, school entry ceremony, graduation ceremony, excursion, party or the like).

In step S21, the image attribute setting unit 42 sets a type of sport as a single attribute (soccer, baseball, tennis or the like).

In step S22, the image attribute setting unit 42 sets a type of plant as a single attribute (a flower, a tree or the like).

In step S23, the image attribute setting unit 42 sets a type of hobby as a single attribute (cars, motorbikes, cooking, craftwork or the like).

When the processing of step S23 is complete, the image attribute setting processing ends.

Note that the image data attributes shown in the flowchart in FIG. 9 represent an example; numerous other attributes may be specified.

For example, the following image data attributes may be set: the season and the time of day when the image was captured (spring, summer, autumn, winter, dawn, noon, evening, night and the like); the name of an image data processing software tool or maker name of the same; information relating to people in the subject (sex, age, ethnic group, specific people or groups of people (celebrities, celebrity groups, sports stars, politicians), and the like); information relating to poses of the people in the subject (a peace V-sign, a high five, running, walking, jumping and the like); information relating to principal colors in the image (generally red at sunset, generally green in a mountain photograph, and the like); information relating to a title applied to the image data (“reflection of Mt. Fuji”, “diamond-tipped Mt. Fuji” and the like); information relating to sounds recorded with video image data (birdsong, wave sounds, a running river, the rustling of leaves, insect sounds, cicadas chirping, and the like); and information relating to the frame rate of video image data (60 fps, 300 fps, 1200 fps, or the like). Further yet, information on other values relating to subjects may be set as image data attributes (for example, pet names, plant names, animal names, insect names, bird names, fish names, the sun, the moon, star names, the aurora, meteor swarms, trains, cars, motorbikes, boats, mascot names, texts shown in the images, and types of food (ramen, curry, etc)).

These various attributes may be grouped by high-level concepts, similarities and the like, and counts may be obtained in the slideshow attribute setting processing, which is described below, both for each attribute value and for each group.

In the slideshow attribute setting processing, of the numerous attributes described above, attributes that can be set are set as appropriate for the data of each image.

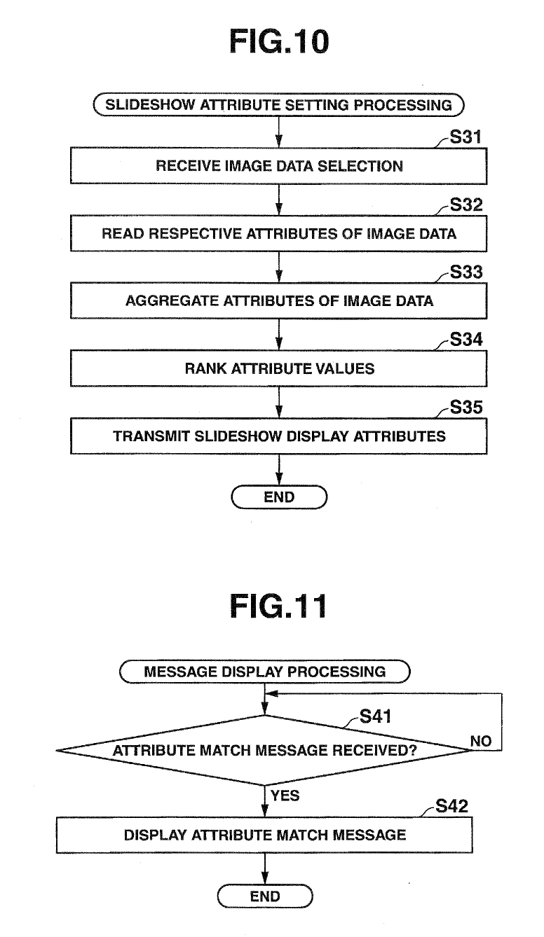

Now, of the processes executed by the digital photo frame 10 with the functional structures in FIG. 4, the slideshow attribute setting processing is described with reference to FIG. 10.

FIG. 10 is a flowchart describing the flow of the slideshow attribute setting processing executed by the digital photo frame 10 with the functional structures of FIG. 4.

In the present embodiment, after the power supply of the digital photo frame 10 is turned on, the slideshow attribute setting processing is executed when an instruction specifying a slideshow display is inputted.

In step S31, the slideshow attribute setting unit 43 receives selections of image data to be displayed in the slideshow, from the image data stored in the image database 41.

In step S32, the slideshow attribute setting unit 43 reads the attributes set for the image data selected as data of images to be displayed in the slideshow, from the image database 41.

In step S33, the slideshow attribute setting unit 43 aggregates the attributes of the image data to be displayed in the slideshow.

At this time, the slideshow attribute setting unit 43 aggregates the image data attributes by, for each of the various attributes set in the image attribute setting processing, counting numbers of image data sets in the selected image data for which that attribute value is set. Thus, the result of step S33 is that a count is obtained for each attribute value.

In step S34, the slideshow attribute setting unit 43 sorts the aggregated image data attribute values into count order. The results of this sorting are set as overall attributes of the slideshow display. Here, after the aggregated image data attribute values have been ranked in count order, it may be that only the attribute values corresponding to the highest counts (for example the top five) are employed as the overall attributes of the slideshow display.

In step S35, the slideshow attribute setting unit 43 transmits the slideshow display attributes set in step S34 to the server 200. Together therewith, the slideshow attribute setting unit 43 transmits the device ID of the digital photo frame 10 and the client name of the digital photo frame 10 set by the user to the server 200.

When the processing of step S35 is complete, the slideshow attribute setting processing ends.

FIG. 11 is a flowchart describing the flow of the message display processing executed by the digital photo frame 10 with the functional structures of FIG. 4.

In the present embodiment, after the power supply of the digital photo frame 10 is turned on, the message display processing is executed at intervals of a predetermined duration.

In step S41, the message display unit 46 makes a determination as to whether an attribute match message has been received from the server 200.

If an attribute match message has not been received from the server 200, the result of the determination in step S41 is NO, and the processing returns to step S41.

On the other hand, if an attribute match message has been received from the server 200, the result of the determination in step S41 is YES, and the processing advances to step S42.

In step S42, the message display unit 46 displays a display screen with the attribute match message (see FIG. 6).

When the processing of step S42 is complete, the message display processing ends.

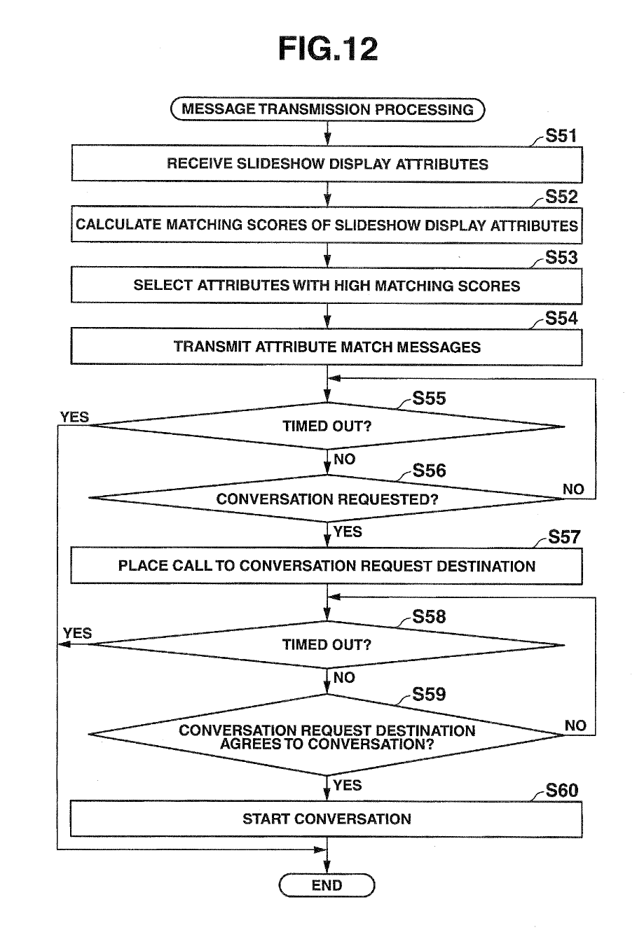

FIG. 12 is a flowchart describing the flow of the message transmission processing executed by the server 200 with the functional structures of FIG. 7.

In the present embodiment, after a power supply of the server 200 is turned on, the message transmission processing is executed at intervals of a predetermined duration.

In step S51, the message transmission unit 232 receives slideshow display attributes from a digital photo frame 10. Here, the message transmission unit 232 receives the device ID and client name of the digital photo frame 10 together with the slideshow display attributes, and stores the received slideshow display attributes in the attribute database 233 in association with the device ID and the client name.

In step S52, the message transmission unit 232 calculates matching scores between the received slideshow display attributes and other slideshow display attributes. Here, the message transmission unit 232 compares counts of the attribute values set in the image data, for the plural slideshow display attributes, and calculates a matching score from the results of these comparisons.

Specifically, if the attribute value with the highest count in one slideshow display is the highest in another slideshow display, 30 points are added, if it is the second highest in the other, 20 points are added, and if it is the third highest in the other, 10 points are added. If the attribute value with the second highest count in the one slideshow display is the highest in the other, 15 points are added, if it is the second highest in the other, 10 points are added, and if it is the third highest in the other, 5 points are added. If the attribute value with the third highest count in the one slideshow display is the first, second or third highest in the other, 5 points are added.

In step S53, the message transmission unit 232 selects the attributes of any slideshow display with a high matching score calculated in step S52 (for example, a slideshow display with a matching score of 70 points or more).

In this case, the attribute values are compared, and attributes that have a certain similarity between slideshow displays are selected as matching attributes. Alternatively, it may be that only attributes that are exactly the same between the slideshow displays are selected as matching attributes.

In step S54, the message transmission unit 232 transmits attribute match messages including the matching client names and matching score to both the digital photo frame 10 that is the source of transmission of the slideshow display attributes received in step S51 and a digital photo frame 10 that was the source of transmission of the slideshow display attributes selected in step S53.

In step S55, the message transmission unit 232 makes a determination as to whether a waiting period has timed out.

If the waiting period has timed out, the result of the determination in step S55 is YES, and the message transmission processing ends.

On the other hand, if the waiting period has not timed out, the result of the determination in step S55 is NO and the processing advances to step S56.

In step S56, the message transmission unit 232 makes a determination as to whether a request for a conversation has been received from any of the digital photo frames 10.

If no request for a conversation has been received from any of the digital photo frames 10, the result of the determination in step S56 is NO and the processing returns to step S55.

On the other hand, if a request for a conversation has been received from any of the digital photo frames 10, the result of the determination in step S56 is YES and the processing advances to step S57.

In step S57, the message transmission unit 232 places a call to the digital photo frame 10 that is the requested destination of the conversation.

In step S58, the message transmission unit 232 makes a determination as to whether a waiting period has timed out.

If the waiting period has timed out, the result of the determination in step S58 is YES, and the message transmission processing ends.

On the other hand, if the waiting period has not timed out, the result of the determination in step S58 is NO and the processing advances to step S59.

The waiting periods for which time-out determinations are made in step S55 and step S58 are not shown in the drawings, but may be set in accordance with the slideshow display matching score calculated in step S52. For example, if a matching score is high (90 points or more), this is unusual and the waiting periods may be set to be twice as long.

In step S59, the message transmission unit 232 makes a determination as to whether the digital photo frame 10 that is the destination of the conversation request has agreed to the conversation request.

If the digital photo frame 10 that is the destination of the conversation request has not agreed to the conversation request, the result of the determination in step S59 is NO and the processing returns to step S58.

On the other hand, if the digital photo frame 10 that is the destination of the conversation request does agree to the conversation request, the result of the determination in step S59 is YES and the processing advances to step S60.

In step S60, the message transmission unit 232 starts a conversation between the digital photo frame 10 that is the destination of the conversation request and the digital photo frame 10 that is the source of the conversation request.

When the processing of step S60 is complete, the message transmission processing ends.

when the execution of a slideshow display at a digital photo frame 10 ends, an end notification message indicating that the slideshow display has ended is transmitted from the digital photo frame 10 to the server 200. At the server 200, when the end notification message is received, the slideshow display attributes associated with the transmission source digital photo frame 10 are erased from the attribute database 233.

Thus, only digital photo frames 10 that are currently running a slideshow display are objects of the message transmission processing. Therefore, users who are running slideshow displays may communicate through images in real time.

As described hereabove, in the first embodiment of the digital photo frame system 1, the plural digital photo frames 10 and the server 200 are connected via the network N. Each digital photo frame 10 is provided with the image attribute setting unit 42, the slideshow attribute setting unit 43 and the message display unit 46, and the server 200 is equipped with the message transmission unit 232.

The image attribute setting unit 42 of the digital photo frame 10-2, which is running a slideshow display, executes the image attribute setting processing each time new image data is stored in the image database 41. Thus, various attributes are set for the image data. The slideshow attribute setting unit 43 then executes the slideshow attribute setting processing. Thus, attributes set in the image data selected for the slideshow display are aggregated, and overall attributes of the slideshow display are set and transmitted to the server 200. The message transmission unit 232 of the server 200 executes the message transmission processing. Thus, overall slideshow display attributes are received from the digital photo frame 10-2, and matching scores between the attributes of other slideshow displays that are stored in the attribute database 233 and the slideshow display attributes received from the digital photo frame 10-2 are calculated. The message transmission unit 232 then transmits attribute match messages to the digital photo frame 10-2 and the digital photo frame 10-1, which is running a slideshow display with attributes matching the slideshow display attributes of the digital photo frame 10-2. The message display unit 46 at each of the digital photo frames 10-1 and 10-2 executes the message display processing. Thus, if an attribute match message is received, the attribute match message display screen is displayed. In the attribute match message display screen, the client name of the other digital photo frame 10 running a slideshow display with matching attributes, the matching score, a keyword and an image representing the matching of attributes are displayed. With this as a prompt, a conversation may be implemented in accordance with a request from a user.

In other words, according to the digital photo frame system 1 relating to the present embodiment, on the basis of matching scores based on hobbies, preferences and the like that are set by users, the users may communicate through images, prompted by information that is of greater interest

With this configuration, the digital photo frame system 1 provides, for example, the following concrete effects.

The grandparents G and grandchild A who are the users of the digital photo frames 10-1 and 10-2 go on a trip together and, after returning to their respective homes, run slideshow displays of images, from digital cameras that captured images during the trip, on the digital photo frames 10-1 and 10-2. Accordingly, overall slideshow display attributes are transmitted from the digital photo frames 10-1 and 10-2 to the server 200, and a matching score of these attributes is calculated. The slideshow display attributes of the digital photo frames 10-1 and 10-2 match, because the slideshow displays are based on images of the same trip with the same people, and attribute match messages are transmitted to the digital photo frames 10-1 and 10-2. At the digital photo frames 10-1 and 10-2, the attribute match message display screens are displayed. Thus, the fact that images of the trip are being displayed in slideshows in the homes of the grandparents G and grandchild A is reported. The grandparents G or grandchild A check the attribute match message and, with the message as a prompt, may communicate by starting a conversation with one another or sending an e-mail or the like.

In another example, users C and D who are fans of celebrity S are the users of the digital photo frames 10-1 and 10-2. After a concert by celebrity S, if users C and D run slideshow displays of photographs of the concert at the digital photo frames 10-1 and 10-2, each is notified by an attribute match message that the other is viewing photographs of the concert by celebrity S at the other of the digital photo frames 10-1 and 10-2.

In response, users C and D may use a communication tool such as e-mail or the like to discuss the concert and exchange photographs.

### Application Example 1

In the first embodiment, it is described that the message transmission unit 232 of the server 200 compares counts of attribute values set in image data for plural slideshow display attributes, calculates a matching score on the basis of the comparisons, and selects slideshow displays with matching attributes.

Specifically, in the first embodiment, if the attribute value with the highest count in one slideshow display is the highest in another slideshow display, 30 points are added, 20 points if it is the second highest, and 10 points if it is the third highest. If the attribute value with the second highest count in the one slideshow display is the highest in the other, 15 points are added, 10 points if it is the second highest, and 5 points if it is the third highest, and if the attribute value with the third highest count in the one slideshow display is first to third highest in the other, 5 points are added. The scores serve as the matching score, and a slideshow display with a high matching score is selected as being a slideshow display with matching attributes.

In contrast, in this Application Example, for each attribute value of image data, a number of sets of image data for which the attribute is set in a slideshow display is counted, and attribute values with high counts are extracted. For example, the mountain name is set to “Mount Takao” in the data of 10 images, the combination of people in the subject is set to “child” in the data of 7 images, the facial expression of people in the subject is set to “smiling” in the data of 5 images, and other attribute values are 4 or less. In this case, the attribute values that are extracted are mountain name “Mount Takao” in top place, combination of people in the subject “child” in second place, and facial expression of people in the subject “smiling” in third place. Then, another slideshow display in which these attribute values have high counts is selected as a slideshow display with matching attributes. For example, a slideshow display in which mountain name “Mount Takao” is in top place in the slideshow display attributes, a slideshow display in which combination of people in the subject “child” is in top place, and a slideshow display in which facial expression of people in the subject “smiling” is in top place would be selected as slideshow displays with matching attributes.

In other words, in the first embodiment, slideshow displays whose attributes match one another reflecting overall attributes of the slideshow displays are selected, while in the present application example, slideshow displays that share characteristic attribute values are selected as slideshows whose attributes match one another.

Hence, when attribute match messages are displayed, the client names are displayed in order of other digital photo frames 10 that are running slideshow displays with similar characteristic attribute values. The shared characteristic attribute values are displayed together with the client names.

Thus, a user may check the shared characteristic attribute values, and request a conversation with another digital photo frame 10 that matches their own hobbies, preferences and the like.

It should be noted that the present invention is not limited to the embodiment described above, and any modifications and improvements thereto within a scope that can realize the object of the present invention are included in the present invention.

In the above embodiment, a case of a slideshow display in which pre-selected images are all displayed in sequence is described as an example. However, the present invention is applicable to image data that conforms to other specified conditions (image data with a high possibility of being displayed). For example, the present invention may be applied in cases other than a slideshow display, by attributes set in image data saved to a particular folder being aggregated and overall attributes being set in the manner of setting overall attributes of a slideshow display in the above embodiment.

In the above embodiment, the removable medium 31 is used as an image provision medium but this is not a limitation. For example, a memory unit (a hard disk or the like) in another device on the network (a server or the like) may be used.

In the above embodiment, an example in which the image display system in which the present invention is applied is a digital photo frame system in which plural digital photo frames and a server are connected via a network is described, but this is not a particular limitation.

For example, the image display apparatus according to the present invention may be applied generally to electronic equipment with image display functions. Specifically, the image display apparatus according to the present invention is applicable to, for example, notebook computers, printers, television sets, video cameras, portable navigation devices, portable telephones, portable video game machines and so forth.

The processing sequences described above can be executed by hardware, and also can be executed by software.

That is, the functional structures in FIG. 4 and FIG. 7 are merely examples and are not particularly limiting. In other words, it is sufficient that the image display apparatus be provided with functions capable of executing the above-described sequence of processing as a whole; the kinds of functional blocks used for executing the functions are not particularly limited by the examples in FIG. 4 and FIG. 7.

Moreover, a single functional block may be constituted by a hardware unit, may be constituted by a software unit, and may be constituted by a combination thereof.

In a case in which the processing sequence is to be executed by software, a program configuring the software is installed from a network or a storage medium into a computer or the like.

This computer may be a computer incorporating special-purpose hardware. The computer may also be a computer capable of executing different kinds of functions in accordance with the installation of different programs, for example, a general-purpose personal computer.

A recording medium containing the program is not just configured by the removable medium 31 or 331 of FIG. 2 and FIG. 3, which is distributed separately from an apparatus main body for provision of the program to users, and may be configured by a recording medium or the like that is provided to users having been incorporated in the apparatus main body beforehand. The removable medium 31 or 331 is constituted by, for example, a magnetic disc (including floppy disks), an optical disc, a magneto-optical disc or the like. The optical disk is composed of a CD-ROM (Compact Disc-Read Only Memory), a DVD (Digital Versatile Disc), or the like, for example. The magneto-optical disk is composed of an MD (Mini-Disk) or the like. The recording medium that is provided to users having being incorporated into the apparatus main body beforehand is configured by, for example, the ROM 12 or ROM 212 of FIG. 2 and FIG. 3, in which the program is recorded, a hard disc included in the memory unit 19 or 218 of FIG. 2 and FIG. 3, or the like.

It should be noted that, in the present specification, the steps describing the program recorded in the storage medium include not only the processing executed in series following this order, but also processing executed in parallel or individually that is not necessarily executed serially.

Moreover, the term “system” as used in the present specification is intended to include the whole of equipment constituted by plural devices, plural units and the like.

A number of embodiments of the present invention are explained hereabove. These embodiments are merely examples and do not limit the technical scope of the invention. The present invention may be attained by numerous other embodiments, and numerous modifications such as omissions, substitutions and the like are possible within a technical scope not departing from the spirit of the invention.

What is claimed is:

1. An image display system comprising: a plurality of image display apparatuses that display images based on image data;
and a server connected with the plurality of image display apparatuses via a network, wherein
each image display apparatus includes:
an image attribute setting unit that sets an attribute relating to the image data for each set of image data;
an image data storage unit that stores the image data in association with the attributes relating to the image data set by the image attribute setting unit;
a display attribute setting unit that refers to the image data and attributes relating to the image data stored at the image data storage unit, aggregates the attributes set for a plurality of sets of image data that are selected as objects to be displayed, and sets an attribute of the objects to be displayed;
a transmission unit that transmits the attribute of the objects to be displayed set by the display attribute setting unit to the server together with identification information of the image display apparatus; and
a message display unit that displays an attribute match message that is transmitted from the server to report that another of the image display apparatuses matches the attribute of the objects to be displayed,
and
the server includes:
an attribute data storage unit that stores the attributes of objects to be displayed that are transmitted from the image display apparatuses, in association with the identification information of the image display apparatuses; and
a message transmission unit that, if a plurality of the attributes of objects to be displayed stored at the attribute data storage unit match, transmits an attribute match message to each of the image display apparatuses associated with the plurality of attributes of objects to be displayed, on the basis of the identification information of the image display apparatuses.

2. An image display apparatus in an image display system that includes: a plurality of image display apparatuses that display images based on image data; and a server connected with the plurality of image display apparatuses via a network, the image display apparatus comprising:
an image attribute setting unit that sets an attribute relating to the image data for each set of image data;
an image data storage unit that stores the image data in association with the attributes relating to the image data set by the image attribute setting unit;
a display attribute setting unit that refers to the image data and attributes relating to the image data stored at the image data storage unit, aggregates the attributes set for a plurality of sets of image data that are selected as objects to be displayed, and sets an attribute of the objects to be displayed;
a transmission unit that transmits the attribute of the objects to be displayed set by the display attribute setting unit to the server together with identification information of the image display apparatus; and
a message display unit that displays an attribute match message that is transmitted from the server to report that another of the image display apparatuses matches the attribute of the objects to be displayed.

3. The image display apparatus according to claim 2, wherein the display attribute setting unit aggregates the attributes of the image data by counting, for each value of the attribute of the image data, a number of sets of image data in the plurality of sets of image data selected as objects to be displayed for which that value of the attribute is set.

4. The image display apparatus according to claim 2, wherein the message display unit displays information representing the other image display apparatus that matches the attribute of the objects to be displayed that is reported by the attribute match message, and information representing a degree of matching of the attribute of the objects to be displayed.

5. The image display apparatus according to claim 4, wherein the message display unit further displays information representing a characteristic of the matching of the attribute of the objects to be displayed that is reported by the attribute match message.

6. The image display apparatus according to claim 2, further comprising a conversation control unit that controls a conversation with the other image display apparatus, wherein
the message display unit displays a screen that receives input of an instruction to implement a conversation with the other image display apparatus that matches the attribute of the objects to be displayed that is reported by the attribute match message, and,
in response to input of the instruction to implement a conversation at the screen displayed by the message display unit, the conversation control unit controls the conversation with the other image display apparatus.

7. The image display apparatus according to claim 2, wherein the image attribute setting unit sets the attribute relating to the image data by setting a tag representing a type based on a hobby or preference of a user.

8. An image display method of an image display apparatus that structures an image display system including: a plurality of image display apparatuses that display images based on image data; and a server connected with the plurality of image display apparatuses via a network, the image display method comprising:
an image attribute setting step that sets an attribute relating to the image data for each set of image data;
an image data storing step that stores the image data in association with the attributes relating to the image data set in the image attribute setting step;
a display attribute setting step that refers to the image data and attributes relating to the image data stored in the image data storing step, aggregates the attributes set for a plurality of sets of image data that are selected as objects to be displayed, and sets an attribute of the objects to be displayed;
a transmitting step that transmits the attribute of the objects to be displayed set in the display attribute setting step to the server together with identification information of the image display apparatus; and
a message displaying step that displays an attribute match message that is transmitted from the server to report that another of the image display apparatuses matches the attribute of the objects to be displayed.

9. Medium storing a program executable by a computer for controlling an image display apparatus in an image display system including: a plurality of image display apparatuses that display images based on image data; and a server connected with the plurality of image display apparatuses via a network, the program causing the computer to realize:
an image attribute setting function that sets an attribute relating to the image data for each set of image data;
a display attribute setting function that refers to the image data and attributes relating to the image data, aggregates the attributes set for a plurality of sets of image data that are selected as objects to be displayed, and sets an attribute of the objects to be displayed;
a transmission function that transmits the attribute of the objects to be displayed set by the display attribute setting function to the server together with identification information of the image display apparatus; and
a message display function that displays an attribute match message that is transmitted from the server to report that another of the image display apparatuses matches the attribute of the objects to be displayed.

10. A server in an image display system that includes: a plurality of image display apparatuses that display images based on image data; and a server connected with the plurality of image display apparatuses via a network, the server comprising:
an attribute data storage unit that stores, in association with identification information of an image display apparatus, an attribute of objects to be displayed that is transmitted from the image display apparatus, the attribute of objects to be displayed being set by aggregating attributes relating to the image data that are set for a plurality of sets of the image data that are selected as the objects to be displayed; and
a message transmission unit that, if a plurality of the attributes of objects to be displayed stored at the attribute data storage unit match, transmits an attribute match message to each of the image display apparatuses associated with the plurality of attributes of objects to be displayed, on the basis of the identification information of the image display apparatuses, each attribute message reporting that another of the image display apparatuses matches the attribute of objects to be displayed.

11. The server according to claim 10, wherein the message transmission unit calculates a degree of matching of the attributes of objects to be displayed at one image display apparatus and another image display apparatus by, for each value of an attribute of the image data, comparing ranks of the attribute value between the attributes of objects to be displayed at the one image display apparatus and the other image display apparatus, each rank being obtained by counting a number of sets of image data in which that attribute value is set in the plurality of sets of image data selected as objects to be displayed, and adding to the degree of matching a value set in accordance with the ranks of the attribute value.

12. An image display method of a server that structures an image display system including: a plurality of image display apparatuses that display images based on image data; and the server, which is connected with the plurality of image display apparatuses via a network, the image display method comprising:
an attribute data storing step that stores, in association, identification information of an image display apparatus and an attribute of objects to be displayed that is transmitted from the image display apparatus, the attribute of objects to be displayed being set by aggregating attributes relating to the image data that are set for a plurality of sets of the image data that are selected as the objects to be displayed; and
a message transmitting step that, if a plurality of the attributes of objects to be displayed stored in the attribute data storing step match, transmits an attribute match message to each of the image display apparatuses associated with the plurality of attributes of objects to be displayed, on the basis of the identification information of the image display apparatuses, each attribute message reporting that another of the image display apparatuses matches the attribute of objects to be displayed.

13. Medium storing a program executable by a computer for controlling a server in an image display system including: a plurality of image display apparatuses that display images based on image data; and the server, which is connected with the plurality of image display apparatuses via a network, the program causing the computer to realize:
a message transmission function that refers to attributes of objects to be displayed, which correspond with identification information of the image display apparatuses, each attribute of objects to be displayed being set by aggregating attributes relating to the image data that are set for a plurality of sets of image data that are selected as the objects to be displayed, and if a plurality of the attributes of objects to be displayed match, transmits an attribute match message to each of the image display apparatuses associated with the plurality of attributes of objects to be displayed, on the basis of the identification information of the image display apparatuses, each attribute message reporting that another of the image display apparatuses matches the attribute of objects to be displayed.
